(19) United States
(12) Patent Application Publication
(10) Pub. No.: US 2020/0019354 A1
(43) Pub. Date: Jan. 16, 2020

(54) IMAGE FORMING APPARATUS AND IMAGE FORMING METHOD

(71) Applicant: TOSHIBA TEC KABUSHIKI KAISHA, Tokyo (JP)

(72) Inventor: Katsuhiko TSUCHIYA, Numazu Shizuoka (JP)

(21) Appl. No.: 16/031,262

(22) Filed: Jul. 10, 2018

(51) Int. Cl. G06F 3/12; H04N 1/00

(52) U.S. Cl. CPC G06F 3/1221; H04N 1/00543; G06F 3/122; G06F 3/1234; H04N 1/00663; G06F 3/1217; G06F 3/1239

(57) ABSTRACT

An image forming apparatus includes a cover that is opened to permit an operator to access an interior of the image forming apparatus to install a toner cartridge in the image forming apparatus, an image forming unit configured to form an image with toner supplied from the installed toner cartridge, and a control unit configured to execute a process to determine whether or not the installed toner cartridge is genuine upon detecting that the image forming apparatus is in a first state and upon detecting that the cover has been opened and then closed for a time period and the time period exceeds a threshold time period.

### FIELD

Embodiments described herein relate generally to an image forming apparatus and an image forming method.

### BACKGROUND

In the related art, in an image forming apparatus, a toner cartridge is replaced while the image forming apparatus is not in an active state. The replaced toner cartridge may not be a genuine product in some cases. For that reason, when the image forming apparatus transitions from the off state to the on state, the image forming apparatus performs a process of determining whether all the toner cartridges attached thereto are genuine products or not. Therefore, it takes time to activate the image forming apparatus. Such a problem occurs not only when the image forming apparatus is powered on, but also when the image forming apparatus transitions from a power saving state such as a sleep state to a normal state where image formation is possible.

### DESCRIPTION OF THE DRAWINGS

FIG. 1 is an external view illustrating an image forming apparatus of a first embodiment.

FIG. 2 is a diagram illustrating a hardware configuration of the image forming apparatus according to the first embodiment.

FIG. 3 is a block diagram illustrating a functional configuration of the image forming apparatus according to the first embodiment.

FIG. 4 is a flowchart illustrating a flow of a genuine product determination process according to the first embodiment.

FIG. 5 is a diagram illustrating a hardware configuration of an image forming apparatus according to a second embodiment.

FIG. 6 is a diagram illustrating a functional configuration of the image forming apparatus according to the second embodiment.

FIG. 7 is a flowchart illustrating a flow of a genuine product determination process according to the second embodiment.

### DETAILED DESCRIPTION

An image forming apparatus according to an embodiment includes a cover that is opened to permit an operator to access an interior of the image forming apparatus to install a toner cartridge in the image forming apparatus, an image forming unit configured to form an image with toner supplied from the installed toner cartridge, and a control unit configured to execute a process to determine whether or not the installed toner cartridge is genuine upon detecting that the cover has been opened and then closed for a time period and the time period exceeds a threshold time period.

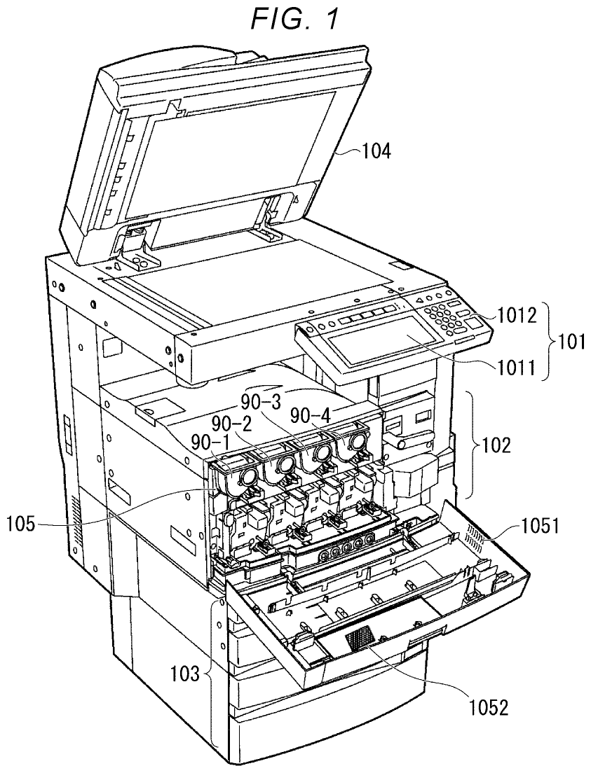

FIG. 1 is an external view illustrating an image forming apparatus 1 of a first embodiment. The image forming apparatus 1 is, for example, a multifunction apparatus (an MFP). The image forming apparatus 1 includes an input and output unit 101, an image forming unit 102, a sheet storage unit 103, an image reading unit 104, and a mounting unit 105. The image forming unit 102 of the image forming apparatus 1 may be an electrophotographic device for forming a toner image on an image forming media or an ink jet type device.

The input and output unit 101 includes a display 1011 and a control panel 1012. The display 1011 is an image display device such as a liquid crystal display and an organic EL (Electro Luminescence) display. The display 1011 displays various information related to the image forming apparatus 1. The control panel 1012 has a plurality of input operation elements, such as keys or buttons. The control panel 1012 receives user's operation. The control panel 1012 outputs a signal corresponding to the operation performed by the user on the control unit of the image forming apparatus 1. The display 1011 and the control panel 1012 may be an integral touch panel.

The image forming unit 102 forms an image on a sheet based on image information generated by the image reading unit 104 or image information received via a communication path. The image forming unit 102 forms an image by the following process, for example. The image forming unit 102 forms an electrostatic latent image on a photosensitive drum based on image information. The image forming unit 102 forms a visible image by adhering developer to the electrostatic latent image. An example of the developer is a toner. A transfer unit of the image forming unit 102 transfers the visible image onto a sheet. A fixing unit of the image forming unit 102 fixes the visible image on the sheet by applying heat and pressure to the sheet. The sheet on which the image is formed may be a sheet stored in the sheet storage unit 103 or may be a sheet fed by hand.

The sheet storage unit 103 stores sheets used for image formation by the image forming unit 102.

The image reading unit 104 reads image information to be read as reflected light and shade of light from an image on a sheet being read. The image reading unit 104 records the read image information. The recorded image information may be transmitted to another information processing apparatus via a network. Regarding the recorded image information, an image may be formed on the sheet by the image forming unit 102.

Toner cartridges 90-1 to 90-4 are replaceably attached to the mounting unit 105. The toner cartridges 90-1 to 90-4 supply a toner used for image formation by the image forming unit 102. The mounting unit 105 electrically connects the toner cartridges 90 to the image forming apparatus 1. Hereinafter, in a case where the toner cartridges 90-1 to 90-4 are not distinguished from each other, the toner cartridges 90-1 to 90-4 are each referred to as a toner cartridge 90. The image forming apparatus 1 does not necessarily have to have four toner cartridges, and may have any number of toner cartridges as long as the number of toner cartridges is one or more. The mounting unit 105 includes a cover 1051 and an opening and closing sensor 1052.

The cover 1051 is a lid of the mounting unit 105 that can be opened and closed. The cover 1051 is opened when the toner cartridge 90 is replaced. The cover 1051 is closed when an image is formed by the image forming apparatus 1.

The opening and closing sensor 1052 detects whether the cover 1051 is open or closed. The opening and closing sensor 1052 outputs cover open information indicating that the cover 1051 is open when the cover 1051 is open. The opening and closing sensor 1052 outputs cover closed information indicating that the cover 1051 is closed when the cover 1051 is closed. The opening and closing sensor 1052 may be any sensor as long as it can detect opening and closing of the cover 1051. The opening and closing sensor 1052 may be, for example, a sensor optically detecting opening and closing of the cover 1051. The opening and closing sensor 1052 may be, for example, a sensor that detects opening and closing of the cover 1051 by a difference in pressure applied to the opening and closing sensor 1052 by the cover 1051.

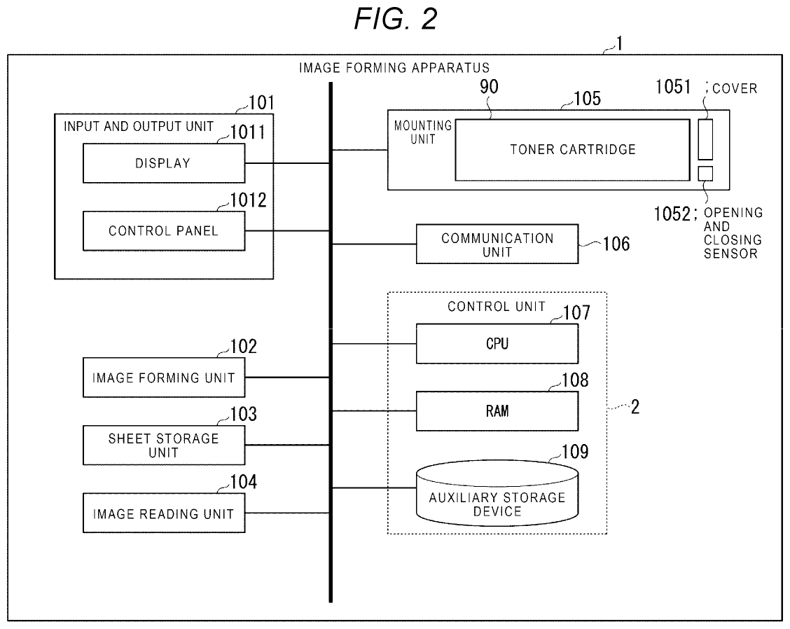

FIG. 2 is a diagram illustrating a hardware configuration of the image forming apparatus 1 according to the first embodiment. The image forming apparatus 1 includes the input and output unit 101, the image forming unit 102, the sheet storage unit 103, the image reading unit 104, the mounting unit 105, a communication unit 106, a central processing unit (CPU) 107, a random access memory (RAM) 108 and an auxiliary storage device 109, and they are connected to each other by a bus. The CPU 107 executes a program using the RAM 108 and the auxiliary storage device 109 and functions as a control unit 2. The control unit 2 controls the input and output unit 101, the image forming unit 102, the sheet storage unit 103, the image reading unit 104, the mounting unit 105, and the communication unit 106.

The communication unit 106 includes a communication interface for connecting the image forming apparatus 1 with an external apparatus. The communication unit 106 communicates with the external apparatus via a communication line.

The auxiliary storage device 109 is a storage device such as a magnetic hard disk device or a semiconductor storage device. The auxiliary storage device 109 stores usable cartridge information, open and closed state information, and sleep state information. The usable cartridge information is information indicating an identifier of the toner cartridge 90 usable for forming an image by the image forming apparatus 1. Hereinafter, the toner cartridge 90 of which the identifier is an identifier indicated by usable cartridge information is referred to as a genuine product. The cover open and closed state information indicates whether the cover 1051 is open or closed. The sleep state information indicates whether the image forming apparatus 1 is in a sleep state or not. The sleep state is a state in which the image forming apparatus 1 consumes less power than a normal state. The normal state is a state in which image formation by the image forming apparatus 1 is possible. The state in which image formation is possible means a state in which power equal to or greater than predetermined power is already supplied to a predetermined functional unit including the image forming unit 102. When the image forming apparatus 1 is in the sleep state, no image is being formed by the image forming apparatus 1 and thus, there is a possibility that the toner cartridge 90 is replaced.

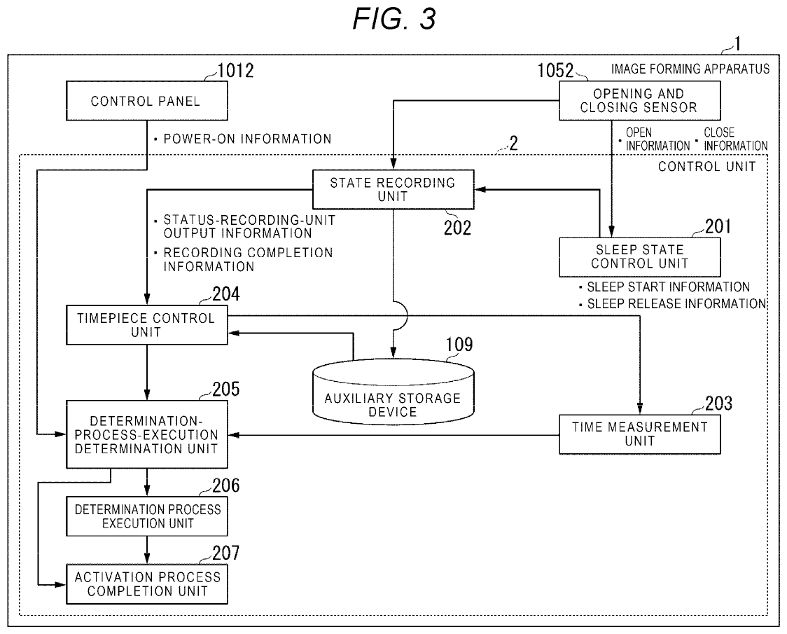

FIG. 3 is a diagram illustrating a functional configuration of the image forming apparatus 1 according to the first embodiment. FIG. 3 is a diagram illustrating functional units related to a genuine product determination process by the image forming apparatus 1. The genuine product determination process is a process of determining whether the toner cartridge 90 mounted on the image forming apparatus 1 is a genuine product or not.

The image forming apparatus 1 includes a sleep state control unit 201, a state recording unit 202, a time measurement unit 203, a timepiece control unit 204, a determination-process-execution determination unit 205, a determination process execution unit 206, and an activation process completion unit 207.

The sleep state control unit 201 controls the transition of the image forming apparatus 1 from a normal state to asleep state and the transition from the sleep state to the normal state.

The sleep state control unit 201 controls the sleep state of the image forming apparatus 1 based on open and closed state information and sleep state information stored in the auxiliary storage device 109. In a case where a sleep state transition condition is satisfied, the sleep state control unit 201 causes the image forming apparatus 1 in the normal state to transition to the sleep state. The sleep state transition condition is a condition which causes the image forming apparatus 1 to transition to the sleep state.

A plurality of sleep state transition conditions may exist. Hereinafter, for the sake of simplicity, description will be made on the assumption that there are two sleep state transition conditions.

One of the sleep state transition conditions is a condition that the cover 1051 is opened (hereinafter, referred to as a “sleep transition first condition”) when the image forming apparatus 1 is not in the sleep state. Specifically, the sleep state control unit 201 causes the image forming apparatus 1 to transition to the sleep state by the following process. When cover open information is acquired, the sleep state control unit 201 refers to sleep state information. When the sleep state information indicates that the image forming apparatus 1 is not in the sleep state, the sleep state control unit 201 causes the image forming apparatus 1 to transition to the sleep transition first state.

Another condition of the sleep state transition condition is a condition that an input to the image forming apparatus 1 is not performed for a predetermined period of time (hereinafter, referred to as “sleep transition second condition”).

In a case where the sleep release condition is satisfied, the sleep state control unit 201 releases the sleep state of the image forming apparatus 1 in the sleep state and causes the image forming apparatus 1 to transition to an activation state. The activation state is a state where the image forming apparatus 1 transitions from a state which is not a normal state to the normal state where image processing can occur. A plurality of sleep release conditions may exist. For the sake of simplicity, the following description will be made assuming that there are two normal state transition conditions.

One of the sleep release conditions is a condition that the cover 1051 is closed when the image forming apparatus 1 is in the sleep state (hereinafter, referred to as “sleep release first condition”). Specifically, the sleep state control unit 201 causes the image forming apparatus 1 to transition to the normal state according to the following process. When cover closed information is acquired, the sleep state control unit 201 refers to sleep state information. When the sleep state information indicates that the image forming apparatus 1 is in the sleep state, the sleep state control unit 201 causes the image forming apparatus 1 to transition to the normal state.

Another condition of the sleep release conditions is a condition that an input to the image forming apparatus 1 is made when the image forming apparatus 1 is in a sleep state and the cover 1051 is in a closed state (hereinafter, referred to as “sleep release second condition”).

When transitioning from the normal state to the sleep state, the sleep state control unit 201 generates sleep start information indicating that the image forming apparatus 1 is caused to transition to the sleep state. When transitioning from the sleep state to the activation state, the sleep state control unit 201 generates sleep release information indicating that the sleep state of the image forming apparatus 1 is released.

The state recording unit 202 acquires the cover open information, the cover closed information, the sleep start information, and the sleep release information, and updates values of the cover open and closed state information and the sleep state information stored in the auxiliary storage device 109. Specifically, the state recording unit 202 acquires the cover open information and updates the value of the cover open and closed state information with a value indicating that the cover 1051 is open (hereinafter, referred to as “open state”). The state recording unit 202 acquires the cover closed information and updates the value of the cover open and closed state information with a value indicating that the cover 1051 is in a closed state (hereinafter, referred to as “closed state”). The state recording unit 202 acquires the sleep start information and updates the value of the sleep state information with a value indicating that it is in the sleep state. The state recording unit 202 acquires the sleep release information and updates the value of the sleep state information with a value indicating that the sleep state information is another state other than the sleep state.

The cover 1051 is opened when the toner cartridge 90 is replaced. For that reason, the open state is a state at which there is a possibility that the toner cartridge 90 may be replaced.

As described above, the sleep state control unit 201 acquires cover open information and generates sleep start information. For that reason, when the cover open information is acquired, the state recording unit 202 also acquires the sleep start information. The state recording unit 202 updates the value of the cover open and closed state information with a value indicating the cover open state after the state recording unit 202 acquires the cover open information. Also, the state recording unit 202 updates the value of the sleep state information with a value indicating the sleep state. As described above, the sleep state control unit 201 acquires the cover closed information and generates the sleep release information. For that reason, in a case where the cover closed information is acquired, the state recording unit 202 also acquires the sleep release information. The state recording unit 202 updates the value of the cover open and closed state information with a value indicating the closed state after the state recording unit 202 acquires the cover close information. Also, the state recording unit 202 updates the value of the sleep state information with a value that does not indicate the sleep state.

The state recording unit 202 outputs the acquired cover open information, cover closed information, sleep start information, and sleep release information to the timepiece control unit 204 together with recording completion information. The recording completion information is information indicating that the state recording unit 202 has updated the value of the cover open and closed state information or the sleep state information. Hereinafter herein, when the cover open information, the cover closed information, the sleep start information, and the sleep release information output by the state recording unit 202 are not distinguished, these pieces of information are referred to as status-recording-unit output information.

The time measurement unit 203 measures time.

When the recording completion information and the status-recording-unit output information are acquired, the timepiece control unit 204 controls start and end of time measurement by the time measurement unit 203 based on the acquired status-recording-unit output information, open and closed state information, and sleep state information.

Specifically, the timepiece control unit 204 executes a measurement start process so as to cause the time measurement unit 203 to start measuring the time. Specifically, the measurement start process is the following process.

When the cover open information or the sleep start information is acquired, the timepiece control unit 204 refers to the cover open and closed state information and the sleep state information stored in the auxiliary storage device 109. The timepiece control unit 204 acquires values of the cover open and closed state information and the sleep state information.

In a case where the cover open and closed state information indicates the open state, the timepiece control unit 204 causes the time measurement unit 203 to start measuring the time.

In a case where the cover open and closed state information indicates the closed state and the sleep state information indicates the sleep state, the timepiece control unit 204 causes the time measurement unit 203 to start measuring the time.

When the cover open and closed state information indicates the closed state and the sleep state information indicates the normal state, the timepiece control unit 204 does not cause the time measurement unit 203 to start measuring the time.

Specifically, the timepiece control unit 204 executes the measurement end process so as to cause the time measurement unit 203 to end measuring the time. Specifically, the measurement end process is the following process.

When the cover closed information or the sleep release information is acquired, the timepiece control unit 204 refers to the cover open and closed state information and the sleep state information stored in the auxiliary storage device 109.

The timepiece control unit 204 acquires values of the cover open and closed state information and the sleep state information.

In a case where the cover open and closed state information indicates that the cover goes into the closed state from the open state, the timepiece control unit 204 causes the time measurement unit 203 to end measuring the time.

When the cover closed information and the sleep release information are acquired, the timepiece control unit 204 causes the time measurement unit 203 to end measuring the time. The timepiece control unit 204 outputs the acquired cover closed information or sleep release information to the determination-process-execution determination unit 205.

The timepiece control unit 204 executes such a measurement start process and measurement end process so as to control the start and end of time measurement by the time measurement unit 203.

The determination-process-execution determination unit 205 determines whether or not to execute the genuine product determination process, based on determination-unit-acquisition information and the time measured by the time measurement unit 203. The determination-unit-acquisition information is any one of the cover closed information or the sleep release information output from the timepiece control unit 204 and power-on and power-off information. The time measured by the time measurement unit 203 is the time from the start of time measurement by control of the timepiece control unit 204 to the end of the time measurement. The genuine product determination process is a process of determining whether the toner cartridge 90 attached to the image forming apparatus 1 is a genuine product or not. Hereinafter, a process of determining whether the determination-process-execution determination unit 205 executes the genuine product determination process or not, based on the determination-unit-acquisition information and the time measured by the time measurement unit 203 is referred to as a determination process.

The power-on information is instruction information the image forming apparatus 1 to power on. The image forming apparatus 1 of which power is turned on is transitioned from an off state to the activation state by a control unit (not illustrated). An off state is a state in which power is not supplied to the image forming apparatus 1. The power-on information is information that is input, by a user, to the image forming apparatus 1.

If the determination-process-execution determination unit 205 determines to execute the genuine product determination process, the determination process execution unit 206 executes the genuine product determination process.

The activation process completion unit 207 executes the normal state transition process. The activation process completion unit 207 executes the normal state transition process so as to cause the image forming apparatus 1 to transition from the activation state to the normal state.

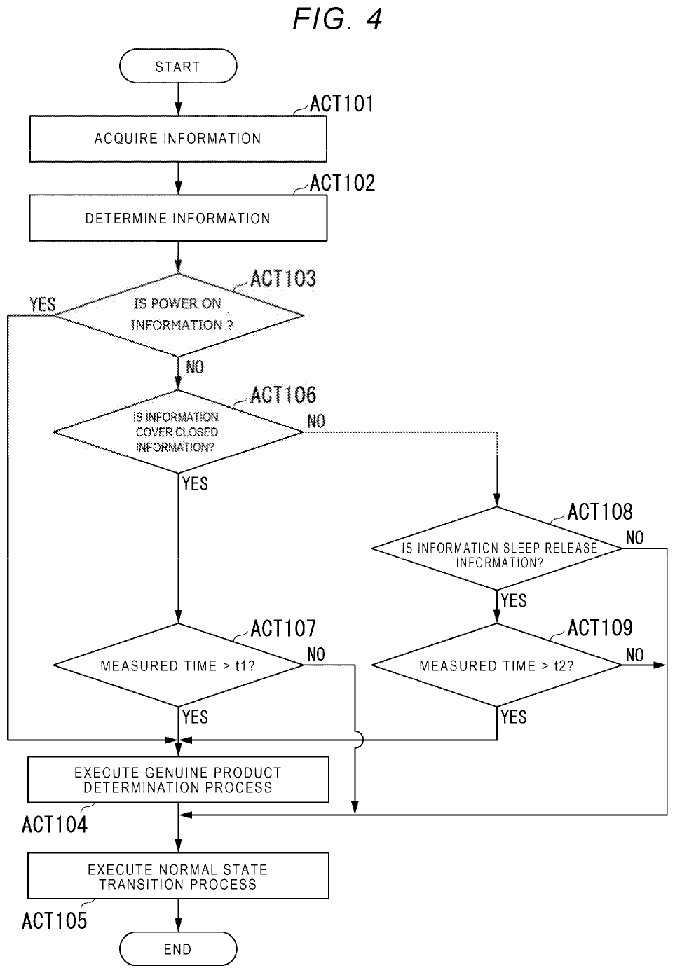

FIG. 4 is a flowchart illustrating a flow of the genuine product determination process according to the first embodiment.

The determination-process-execution determination unit 205 acquires determination-unit-acquisition information (ACT 101). The determination-process-execution determination unit 205 determines whether the obtained determination-unit-acquisition information is power-on information or not (ACT 102). When it is determined that the determination-unit-acquisition information is power-on information (YES in ACT 103), the determination process execution unit 206 executes the genuine product determination process (ACT 104). Subsequent to ACT 104, the activation process completion unit 207 executes the normal state transition process so as to cause the image forming apparatus 1 to transition from the activation state to the normal state (ACT 105).

On the other hand, when it is determined that the determination-unit-acquisition information is not the power-on information (NO in ACT 103), the determination process execution unit 206 determines whether the determination-unit-acquisition information is cover closed information or not (ACT 106). When it is determined that the determination-unit-acquisition information is cover closed information (YES in ACT 106), the determination process execution unit 206 acquires the time measured by the time measurement unit 203, which corresponds to the length of time that the cover 1051 was in the opened state. The determination process execution unit 206 determines whether the acquired time exceeds predetermined time t1 or not (ACT 107). When it is determined that the acquired time exceeds the time t1 (YES in ACT 107), the determination process execution unit 206 executes the genuine product determination process (ACT 104). On the other hand, when it is determined that the acquired time does not exceed the time t1 (NO in ACT 107), the determination process execution unit 206 does not execute the genuine product determination process, and the activation process completion unit 207 executes the normal state transition process (ACT 105).

On the other hand, in ACT 106, when it is determined that the determination-unit-acquisition information is not cover closed information (NO in ACT 106), the determination process execution unit 206 determines whether the determination-unit-acquisition information is sleep release information or not (ACT 108). When it is determined that the determination-unit-acquisition information is the sleep release information (YES in ACT 108), the determination process execution unit 206 acquires the time measured by the time measurement unit 203, which corresponds to the length of time the open and closed state information indicates the closed state and the sleep state information indicates the sleep state. The determination process execution unit 206 determines whether the acquired time exceeds predetermined time t2 set in advance or not (ACT 109). When it is determined that the acquired time exceeds the time t2 (YES in ACT 109), the determination process execution unit 206 executes the genuine product determination process (ACT 104). On the other hand, when it is determined that the acquired time does not exceed the time t2 (NO in ACT 109), the determination process execution unit 206 does not execute the genuine product determination process, and the activation process completion unit 207 executes the normal state transition process (ACT 105).

The image forming apparatus 1 of the first embodiment determines whether or not to execute the genuine product determination process upon activation, and when there is a possibility that the toner cartridge 90 is replaced based on time information. Accordingly, it is possible to suppress an increase in time required for activating the image forming apparatus. There is a high possibility that the toner cartridge 90 will be replaced during the open state or the sleep state of the image forming apparatus 1.

### Second Embodiment

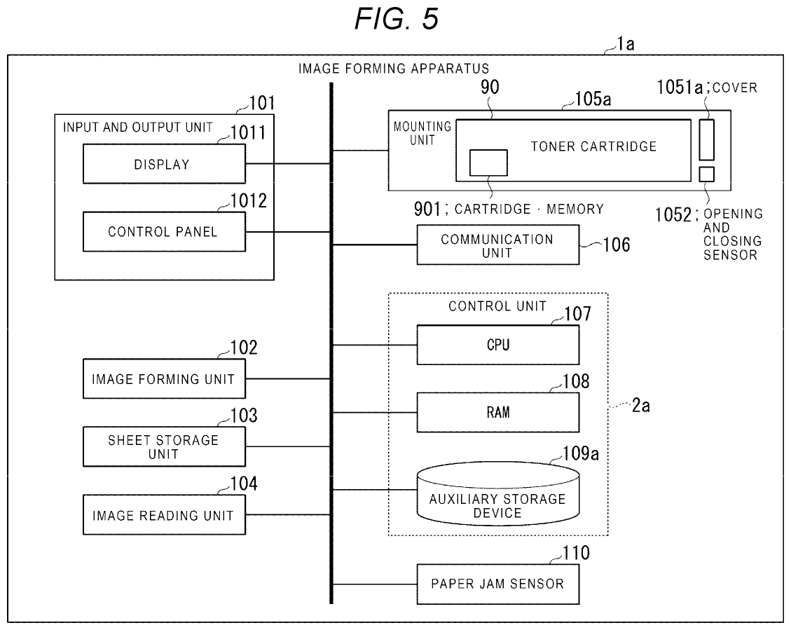

FIG. 5 is a diagram illustrating a hardware configuration of an image forming apparatus 1a according to the second embodiment. The image forming apparatus 1a of the second embodiment differs from the image forming apparatus 1 of the first embodiment in that a mounting unit 105a is provided instead of the mounting unit 105, in that an auxiliary storage device 109a is provided instead of the auxiliary storage device 109 and in that a paper jam sensor 110 is provided. The CPU 107 executes a program using the RAM 108 and the auxiliary storage device 109a and functions as the control unit 2a. Hereinafter, same reference numerals as those of FIG. 2 and FIG. 3 are given to constituents having the same function as those of the image forming apparatus 1, and description thereof will be omitted.

The mounting unit 105a is different from the mounting unit 105 in that a cover 1051a is provided instead of the cover 1051. The cover 1051a is different from the cover 1051 in that the cover 1051a is a lid for covering a portion where a paper jam may occur in the image forming apparatus 1a, in addition to being a lid of the mounting unit 105 that can be opened and closed. The cover 1051a covers a portion where the paper jam occurs. For that reason, if the paper jam occurs in the image forming apparatus 1a, the user needs to open the cover 1051a in order to remove the sheet.

Hereinafter, for the sake of simplicity of explanation, the same reference numerals as those of FIG. 2 and FIG. 3 are given to constituents that have functions similar to those based on opening and closing of the cover 1051 as functions based on opening and closing of the cover 1051a, and description thereof will be omitted.

For example, the opening and closing sensor 1052 in the second embodiment detects whether the cover 1051a is open or closed. The opening and closing sensor 1052 in the second embodiment outputs cover open information when the cover 1051a is opened. The opening and closing sensor 1052 outputs cover closed information when the cover 1051a is closed. For that reason, for the sake of simplicity of explanation, the same reference numerals as the opening and closing sensor 1052 in the first embodiment are given to the opening and closing sensor 1052 in the second embodiment.

The auxiliary storage device 109a is a storage device such as a magnetic hard disk device or a semiconductor storage device. The auxiliary storage device 109a is different from the auxiliary storage device 109 in that it stores paper jam state information, in addition to usable cartridge information, open and closed state information, and sleep state information. The paper jam state information indicates either a paper jam state or a non-paper jam state. The paper jam state is a state in which the paper jam occurs in the image forming apparatus 1a. The non-paper jam state is a state in which the paper jam does not occur in the image forming apparatus 1a.

The paper jam sensor 110 detects that a paper jam has occurred in the image forming apparatus 1a. When the paper jam occurs in the image forming apparatus 1a, the paper jam sensor 110 outputs paper jam start information indicating that the image forming apparatus 1a transitioned to the paper jam state. When the jammed paper is removed from the image forming apparatus 1a, the paper jam sensor 110 outputs paper jam elimination information indicating that the image forming apparatus 1a transitioned to the non-paper jam state.

The paper jam sensor 110 may optically detect the paper jam, for example. The detection method of the paper jam sensor 110, however, is not limited to the optical method.

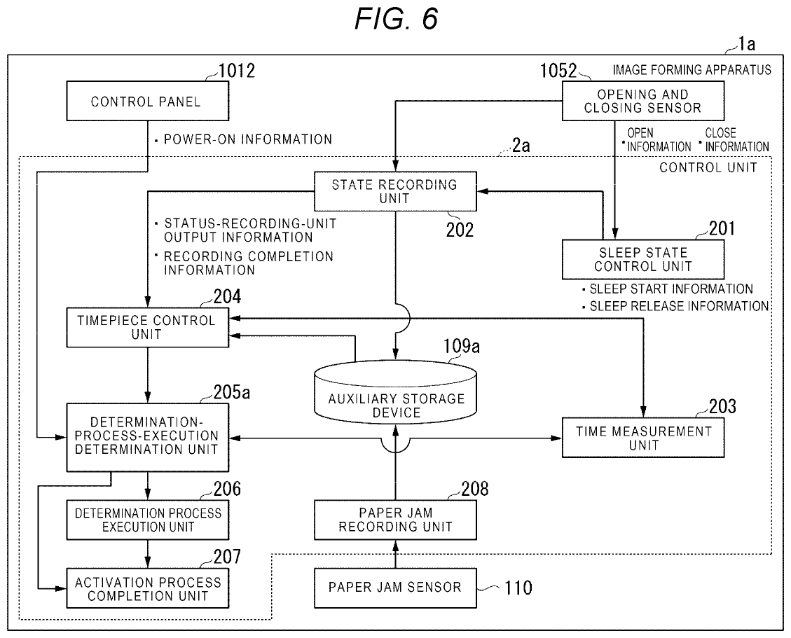

FIG. 6 is a diagram illustrating a functional configuration of the image forming apparatus 1a according to the second embodiment. FIG. 6 is a diagram illustrating functional units related to the genuine product determination process by the image forming apparatus 1a. The image forming apparatus 1a differs from the image forming apparatus 1 in that a determination-process-execution determination unit 205a is provided instead of the determination-process-execution determination unit 205, in that a paper jam recording unit 208 is provided, in that the auxiliary storage device 109a is provided instead of the auxiliary storage device 109 and in that the paper jam sensor 110 is further provided.

The determination-process-execution determination unit 205a performs determination in the determination process also based on the paper jam state information, in addition to the determination-unit-acquisition information and the time measured by the time measurement unit 203.

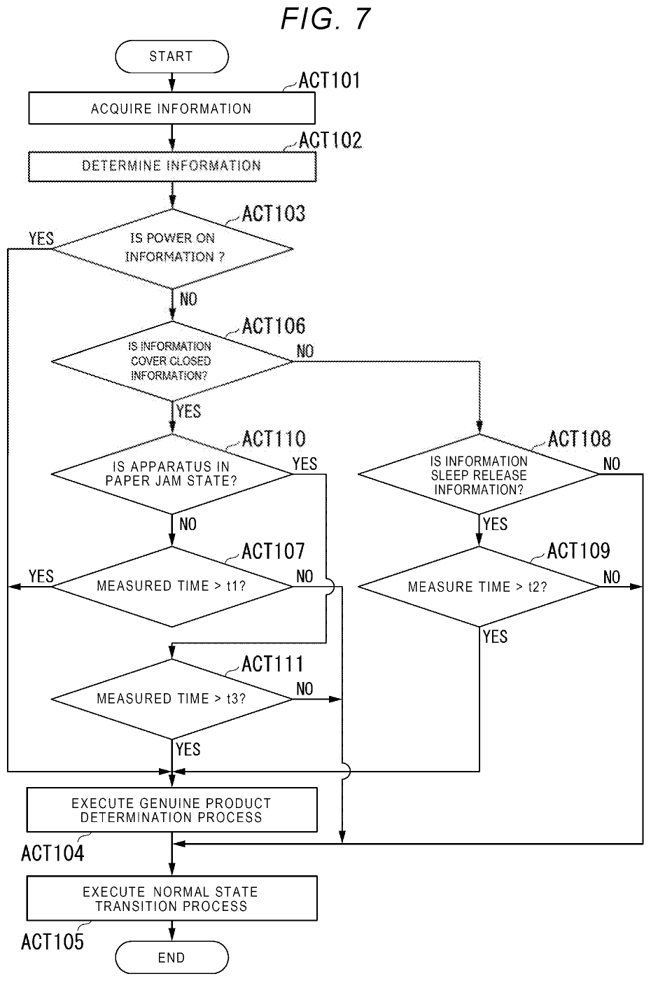

FIG. 7 is a flowchart illustrating a flow of the genuine product determination process according to the second embodiment.

The flowchart of FIG. 7 is different from the flowchart of FIG. 4 in that it includes ACT 110 and ACT 111. Hereinafter, the same reference numerals are given to the same processes as the processes in the flowchart of FIG. 4, and description thereof will be omitted.

In ACT 106, when it is determined that the determination-unit-acquisition information is the cover closed information (YES in ACT 106), the determination process execution unit 206 refers to the paper jam state information and determines whether the image forming apparatus 1a is in a paper jam state or not (ACT 110). When it is determined that the paper jam state information indicates a non-paper jam state (NO in ACT 110), the process of the ACT 107 is executed.

On the other hand, in ACT 110, when it is determined the paper jam state information indicates a paper jam state (YES in ACT 110), the determination process execution unit 206 acquires the time measured by the time measurement unit 203, which corresponds to the length of time the image forming apparatus 1 is in the paper jam state. The determination process execution unit 206 determines whether the acquired time exceeds predetermined time t3 or not. The time t3 may be different from or may be the same time as the time t1. In one embodiment, the time t3 is greater than the time t1.

The image forming apparatus 1a of the second embodiment determines whether or not to execute the genuine product determination process at activation based on the time when there is a possibility that the toner cartridge 90 is replaced, in the state of the image forming apparatus 1a. For that reason, it is possible to suppress an increase in time required for activating the image forming apparatus. There is a high possibility that the toner cartridge 90 will be replaced during the open state, the sleep state, or the paper jam state of the image forming apparatus 1a.

The image forming apparatus 1a may not determine execution of the genuine product determination process during activation based on the time during which the image forming apparatus 1a is in the paper jam state. The image forming apparatus 1a may execute the genuine product determination process at any time when it is possible for the toner cartridge 90 to be replaced. For example, the image forming apparatus 1a execute the genuine product determination process when the waste toner box is exchanged. The determination process execution unit 206 is an example of a cartridge determination unit. The opening and closing sensor 1052 is an example of a cover sensor. The paper jam sensor 110 is an example of a state sensor. The fact that the image forming apparatus 1a is in the open state is an example of the first condition. The fact that the identifier is an identifier indicated by the usable cartridge information is an example of the second condition. It is an example of the third condition to be in a paper jam state.

All or some of the functions of the image forming apparatuses 1 and 1a may be realized by using hardware such as an application specific integrated circuit (ASIC), a programmable logic device (PLD), a field programmable gate array (FPGA), and the like. The program may be recorded on a computer-readable recording medium. The computer-readable recording medium is a storage device, for example, a portable medium such as a flexible disk, a magneto-optical disk, a ROM, a CD-ROM, and a hard disk or the like built in the computer system. The program may be transmitted via an electric communication line.

According to at least one embodiment described above, it is determined whether or not to execute the genuine product determination process upon activation, based on the time during which the image forming apparatus 1 or 1a resides at a state in which there is a possibility that the toner cartridge 90 is replaced. For that reason, it is possible to suppress an increase in time required for activating the image forming apparatus.

In the embodiment described above, the image forming unit is an electrophotographic device and the developer is toner. If the image forming unit is an ink jet type device, the image forming unit is an ink jet head and the developer is ink. Then, the ink cartridge replaces the toner cartridge.

While certain embodiments have been described these embodiments have been presented by way of example only, and are not intended to limit the scope of the inventions. Indeed, the novel embodiments described herein may be embodied in a variety of other forms: furthermore various omissions, substitutions and changes in the form of the embodiments described herein may be made without departing from the spirit of the inventions. The accompanying claims and their equivalents are intended to cover such forms or modifications as would fall within the scope and spirit of the invention.

1. An image forming apparatus comprising:
a cover that is openable for an operator to access an interior of the image forming apparatus to install a toner cartridge in the image forming apparatus;
an image forming device that uses toner supplied from the installed toner cartridge; and
a controller configured to:
determine a first time period during which the cover has been opened, upon determining that the cover is closed;
execute a process to determine whether or not the installed toner cartridge is genuine upon the first time period exceeding a first threshold time period;
determine a second time period during which the image forming apparatus has been in a sleep state, upon determining that the image forming apparatus transitioned out of the sleep state, and
execute the process upon the second time period exceeding a second threshold time period.

2. The apparatus according to claim 1, wherein
the controller is further configured to execute the process upon power-on of the image forming apparatus.

3. The apparatus according to claim 2, further comprising a sensor configured to detect opening and closing of the cover.

4. The apparatus according to claim 3, wherein the controller is configured to determine the first time period based on signals from the sensor.

5. The apparatus according to claim 1, wherein the first threshold time period is set to be less than an expected amount of time for replacing the toner cartridge.

6. An image forming apparatus comprising:
an image forming device that uses toner supplied from a toner cartridge installed in the image forming apparatus; and
a controller configured to:
determine a time period during which the image forming apparatus has been in a sleep state, upon determining that the image forming apparatus transitioned out of the sleep state, and
execute a process to determine whether or not the installed toner cartridge is genuine upon the time period exceeding a threshold time period.

7. The apparatus according to claim 6, wherein
the controller is further configured to execute the process upon power-on of the image forming apparatus.

8. The apparatus according to claim 6, wherein the controller is configured to determine the time period based on a first time at which the image forming apparatus goes into the sleep state, and a second time at which the image forming apparatus wakes up from the sleep state.

9. The apparatus according to claim 8, wherein the controller is configured to cause the image forming apparatus to go into the sleep state when an input to the image forming apparatus is not made for a predetermined period of time.

10. The apparatus according to claim 6, wherein the threshold time period is set to be less than an expected amount of time for replacing the toner cartridge.

11. An image forming apparatus comprising:
a cover that is openable for an operator to access an interior of the image forming apparatus to perform operations including installing a toner cartridge and clearing a paper jam;
an image forming device that uses toner supplied from the installed toner cartridge;
a paper jam sensor configured to optically detect a paper jam in the image forming device; and
a controller configured to:
determine a first time period during which the cover has been opened, upon determining that the cover is closed and the paper jam sensor detects no paper jam;
execute a process to determine whether or not the installed toner cartridge is genuine upon the first time period exceeding a first threshold time period;
determine a second time period passed from detection of the paper jam by the paper jam sensor, upon determining that the cover is closed and the paper jam sensor detected the paper jam; and
execute the process upon the second time period exceeding a second threshold time period.

12. The apparatus according to claim 11, wherein
the controller is further configured to:
determine a third time period during which the image forming apparatus has been in a sleep state, upon determining that the image forming apparatus transitioned out of the sleep state, and
execute the process upon the third time period exceeding a third threshold time period.

13. The apparatus according to claim 12, wherein the controller is configured to determine the third time period based on a first time at which the image forming apparatus goes into the sleep state, and a second time at which the image forming apparatus wakes up from the sleep state.

14. The apparatus according to claim 13, wherein the controller is configured to cause the image forming apparatus goes into the sleep state when an input to the image forming apparatus is not made for a predetermined period of time.

15. The apparatus according to claim 12, wherein the first and second threshold time periods are each set to be less than an expected amount of time for replacing the toner cartridge.

16. (canceled)

17. The apparatus according to claim 11, wherein the first threshold time period is less than the second threshold time period.

18. The apparatus according to claim 11, further comprising a cover sensor configured to detect opening and closing of the cover.

19. The apparatus according to claim 18, wherein the controller is configured to determine the first and second time periods based on signals from the paper jam sensor and the cover sensor.

20. The apparatus according to claim 11, wherein
the controller is further configured to execute the process upon power-on of the image forming apparatus.
